(19) United States
(12) Patent Application Publication
(10) Pub. No.: US 2014/0356579 A1
(43) Pub. Date: Dec. 4, 2014

(54) Polycarbonate-Based Resin Composition for Carrier Tape Having Excellent Electric Conductivity

(71) Applicant: Cheil Industries Inc., Gumi-si (KR)

(72) Inventors: Chan Gyun Shin, Uiwang-si (KR); Jong Cheol Lim, Uiwang-si (KR); Eun Hye Jung, Uiwang-si (KR)

(73) Assignee: Cheil Industries Inc., Gumi-si (KR)

(21) Appl. No.: 14/177,325

(22) Filed: Feb. 11, 2014

(30) Foreign Application Priority Data
May 31, 2013 (KR) 10-2013-0062690

(51) Int. Cl. H01B 1/24

(52) U.S. Cl. CPC H01B 1/24
USPC 428/156; 252/511

(57) ABSTRACT

An electric conductive resin composition comprises about 0.5 to about 5 parts by weight of (C) carbon nanotubes, based on about 100 parts by weight of a base resin comprising about 50 to about 97% by weight of (A) a polycarbonate resin and about 3 to about 50% by weight of (B) a rubber-modified aromatic vinyl resin (B1), a semi-crystalline polymer resin (B2), or a mixture thereof. The electric conductive resin composition has a surface resistance of about 10⁵Ω/□ or less and can have excellent conductivity. Further, the composition can have excellent productivity, tensile strength and/or tensile elongation, and/or generates little dust.

### CROSS-REFERENCE TO RELATED APPLICATION

This application claims priority under 35 USC Section 119 to and the benefit of Korean Patent Application No. 10-2013-0062690, filed May 31, 2013, the entire disclosure of which is incorporated herein by reference.

### FIELD OF THE INVENTION

The present invention relates to a polycarbonate resin composition. More particularly, the present invention relates to a polycarbonate resin composition for carrier tapes that can have excellent electric conductivity.

### BACKGROUND OF THE INVENTION

Generally, light emitting diodes (hereinafter “LEDs”) are produced in a chip state as an electronic component such as semiconductor packages and are then packed with various types of packing materials for safe delivery to users.

The most widely used packing material is a carrier tape, which can be three-layered or mono-layered. A carrier tape carries an electronic component of LEDs chip in a pocket formed inside the carrier tape to prevent external impact during the transportation or the handling of the electronic component.

General conductive resins used for carrier tapes may include a polycarbonate resin comprising a polycarbonate resin and carbon black. However, carrier tapes using carbon black may be contaminated due to generation of carbon black dust. Carrier tapes can also have an intermediate layer consisting of an insulator so that they do not exhibit volume resistance, which can result in poor electric properties.

General polycarbonate resins have a surface resistance of 10¹²Ω/□ but should have a surface resistance of 10⁴ to 10⁶Ω/□ to be used as a conductive resin. Therefore, in order to provide conductivity when using a polycarbonate resin as a matrix, carbon black should be used in an amount of 15 to 35% by weight. However, when there is such a high content of carbon black, an article molded with a polycarbonate resin may have deteriorated mechanical properties, and carbon black dust from abrasion may contaminate the surface of the molded article.

Korean Patent Publication No. 2011-0078205 discloses a polycarbonate resin composition comprising a polycarbonate, a styrene copolymer resin, carbon nanotubes and carbon black. However, the resin composition has a high content of carbon black, and carbon black coming off from the surface of a molded article generates carbon black dust, which contaminates the surface of the molded article.

Therefore, in order to reduce the content of carbon black in the polycarbonate resin, conductive carbon black may be used instead of general carbon black. However, due to the high price of conductive carbon black compared to general carbon black, molded articles molded with polycarbonate resins may have higher prices.

Furthermore, due to high heat resistance of a polycarbonate resin when it is used alone, the polycarbonate resin can have low sheet productivity (production speed, m/hr). It can also be difficult for the polycarbonate resin to exhibit conductivity when extruded in the form of a sheet such as a carrier tape.

### SUMMARY OF THE INVENTION

To solve the aforementioned problems, the present inventors have used a rubber-modified aromatic vinyl resin and/or a semi-crystalline polymer resin with a polycarbonate resin to reduce the heat resistance of the polycarbonate resin and to increase the dispersibility of carbon nanotubes. The resultant polycarbonate resin composition can have excellent electric conductivity, productivity and/or other properties and can generate little or no dust and thus can be useful for carrier tapes.

The present invention provides a polycarbonate resin composition for carrier tapes that can have excellent electric conductivity. The present invention also provides a polycarbonate resin composition for carrier tapes that can have excellent tensile strength. The present invention further provides a polycarbonate resin composition for carrier tapes that can have excellent tensile elongation. The present invention further provides a polycarbonate resin composition for carrier tapes that can have excellent productivity. The present invention further provides a polycarbonate resin composition for carrier tapes that can generate little dust. The aforementioned and other objects of the present invention will be achieved by the present invention as described below.

The polycarbonate resin composition for carrier tapes according to the present invention comprises about 0.5 to about 5 parts by weight of carbon nanotubes (C), based on about 100 parts by weight of a base resin comprising about 50 to about 97% by weight of a polycarbonate resin (A) and about 3 to about 50% by weight of (B) a rubber-modified aromatic vinyl resin (B1), a semi-crystalline polymer resin (B2) or a mixture thereof, wherein the polycarbonate resin composition for carrier tapes has a surface resistance of about 10⁵Ω/□ or less.

The mixture of the rubber-modified aromatic vinyl resin (B1) and the semi-crystalline polymer resin (B2) may comprise about 20 to about 80% by weight of the rubber-modified aromatic vinyl resin (B1) and about 20 to about 80% by weight of the semi-crystalline polymer resin (B2).

The polycarbonate resin (A) may have a weight-average molecular weight of about 10,000 to about 200,000 g/mol.

The rubber-modified aromatic vinyl resin (B1) may include an acrylonitrile-butadiene-styrene copolymer (ABS) resin, a styrene-ethylene-butadiene-styrene copolymer (SEBS) resin, or a combination thereof.

The semi-crystalline polymer resin (B2) may include polyalkylene terephthalate, ethylene vinyl acetate, or a combination thereof.

The polyalkylene terephthalate may include polybutylene terephthalate (PBT) and/or polyethylene terephthalate (PET).

The rubber-modified aromatic vinyl resin (B1) may include an acrylonitrile-butadiene-styrene copolymer (ABS) resin, and the semi-crystalline polymer resin (B2) may include a polybutylene terephthalate (PBT) resin.

The rubber-modified aromatic vinyl resin (B1) may include a styrene-ethylene-butadiene-styrene copolymer (SEBS) resin, and the semi-crystalline polymer resin (B2) may include an ethylene vinyl acetate resin.

The carbon nanotubes (C) may have an average diameter of about 0.5 to about 100 nm and an average length of about 0.005 to about 100 μm. The carbon nanotubes (C) may have an aspect ratio (L/D) of about 500 to about 5,000.

The present invention also can provide a molded article prepared from the polycarbonate resin composition for carrier tapes. The molded article may be an embossed carrier tape.

The molded article of the present invention may have a surface resistance of about 10⁴ to about 10⁵Ω/□ measured in accordance with ASTM D 257 and can have a productivity of about 6.8 to about 8.5 m/min measured in accordance with a production evaluation of a 120 mm (width)×0.4 mm (thickness) sheet. The thickness variation of the measured sheet may be less than about 1%.

The polycarbonate resin composition for carrier tapes according to the present invention can have the advantages of having excellent electric conductivity, productivity, tensile strength and tensile elongation and generating little dust.

### DETAILED DESCRIPTION OF THE INVENTION

The present invention now will be described more fully hereinafter in the following detailed description of the invention in which some but not all embodiments of the invention are described. Indeed, this invention may be embodied in many different forms and should not be construed as limited to the embodiments set forth herein: rather, these embodiments are provided so that this disclosure will satisfy applicable legal requirements.

The present invention relates to a polycarbonate resin composition for carrier tapes that can have excellent electric conductivity, productivity, tensile strength and/or tensile elongation and/or can generate little dust.

The polycarbonate resin composition for carrier tapes according to the present invention can comprise (A) a polycarbonate resin, (B) a rubber-modified aromatic vinyl resin (B1) and/or a semi-crystalline polymer resin (B2), and (C) carbon nanotubes.

The polycarbonate resin composition for carrier tapes according to the present invention can comprise about 0.5 to about 5 parts by weight of the carbon nanotubes (C), based on about 100 parts by weight of a base resin comprising about 50 to about 97% by weight of the polycarbonate resin (A) and about 3 to about 50% by weight of the rubber-modified aromatic vinyl resin (B11), the semi-crystalline polymer resin (B2) or a mixture thereof (B), wherein the polycarbonate resin composition for carrier tapes can have a surface resistance of about 10⁵Ω/□ or less.

Hereinafter, the components of the polycarbonate resin composition for carrier tapes are described in detail as follows.

(A) Polycarbonate Resin

The polycarbonate resin (A) is not limited in this invention. For example, an aliphatic polycarbonate resin, an aromatic polycarbonate resin, a copolycarbonate resin thereof, a copolyestercarbonate resin, a polycarbonate-polysiloxane copolymer resin or a combination thereof may be used as the polycarbonate resin (A). Further, the polycarbonate resin (A) may have a linear or branched structure.

The polycarbonate resin (A) can have a weight-average molecular weight of about 10,000 to about 200,000 g/mol, for example about 15,000 to about 80,000 g/mol, and as another example about 25,000 g/mol.

The polycarbonate resin (A) of the present invention may be prepared by reacting (a1) an aromatic dihydroxy compound with (a2) a carbonate precursor.

(a1) Aromatic Dihydroxy Compound

The aromatic dihydroxy compound (a1) can include one or more compounds represented by the following Chemical Formula 1, or a combination thereof:

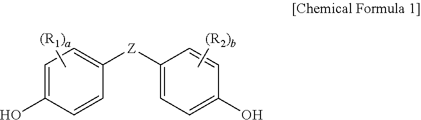

In Chemical Formula 1, R₁ and R₂ can be the same or different and are each independently hydrogen, halogen, or C₁ to C₈ alkyl; a and b can be the same or different and are each independently an integer from 0 to 4; and Z can represent a single bond, C₁ to C₈ alkylene, C₂ to C₈ alkylidene, C₅ to C₁₅ cycloalkylene, C₅ to C₁₅ cycloalkylidene. —S—, —SO—, SO₂—, —O—, or —CO—.

Examples of the aromatic dihydroxy compound (a1) represented by Chemical Formula 1 include without limitation bis(hydroxy aryl)alkanes, bis(hydroxy aryl)cycloalkanes, bis(hydroxy aryl)ethers, bis(hydroxy aryl)sulfides, bis(hydroxy aryl)sulfoxides, biphenyl compounds, and the like, and these compounds may be used alone or in combination of two or more thereof.

Examples of the bis(hydroxy aryl)alkanes may include without limitation bis(4-hydroxy phenyl)methane, bis(3-methyl-4-hydroxy phenyl)methane, bis(3-chloro-4-hydroxy phenyl)methane, bis(3,5-dibromo-4-hydroxy phenyl)methane, 1,1-bis(4-hydroxy phenyl)ethane, 1,1-bis(2-tert-butyl-4-hydroxy-3-methyl phenyl)ethane, 2,2-bis(4-hydroxy phenyl)propane(bisphenol A), 2,2-bis(3-methyl-4-hydroxy phenyl)propane, 2,2-bis(2-methyl-4-hydroxy phenyl)propane, 2,2-bis(3,5-dimethyl-4-hydroxy phenyl)propane, 1,1-bis(2-tert-butyl-4-hydroxy-5-methyl phenyl)propane, 2,2-bis(3-chloro-4-hydroxy phenyl)propane, 2,2-bis(3-fluoro-4-hydroxy phenyl)propane, 2,2-bis(3-bromo-4-hydroxy phenyl)propane, 2,2-bis(3,5-difluoro-4-hydroxy phenyl)propane, 2,2-bis(3,5-dichloro-4-hydroxy phenyl)propane, 2,2-bis(3,5-dibromo-4-hydroxy phenyl)propane, 2,2-bis(4-hydroxy phenyl)butane, 2,2-bis(4-hydroxy phenyl)octane, 2,2-bis(4-hydroxy phenyl)phenyl methane, 2,2-bis(4-hydroxy-1-methyl phenyl)propane, 1,1-bis(4-hydroxy-tert-butyl phenyl)propane, 2,2-bis(4-hydroxy-3-bromo phenyl)propane, 2,2-bis(4-hydroxy-3,5-dimethylphenyl)propane, 2,2-bis(4-hydroxy-3,5-dimethyl phenyl)propane, 2,2-bis(4-hydroxy-3-chloro phenyl)propane, 2,2-bis(4-hydroxy-3,5-dichloro phenyl)propane, 2,2-bis(4-hydroxy-3,5-dibromo phenyl)propane, 2,2-bis(4-hydroxy-3,5-dibromophenyl)propane, 2,2-bis(3-bromo-4-hydroxy-5-chloro phenyl)propane, 2,2-bis(3-phenyl-4-hydroxy phenyl)propane, 2,2-bis(4-hydroxy phenyl)butane, 2,2-bis(3-methyl-4-hydroxy phenyl)butane, 1,1-bis(2-butyl-4-hydroxy-5-methyl phenyl)butane, 1,1-bis(2-tert-butyl-4-hydroxy-5-methyl phenyl)butane, 1,1-bis(2-tert-butyl-4-hydroxy-5-methyl phenyl)isobutane, 1,1-bis(2-tert-amyl-4-hydroxy-5-methyl phenyl)butane, 2,2-bis(3,5-dichloro-4-hydroxy phenyl)butane, 2,2-bis(3,5-dibromo-4-hydro phenyl)butane, 4,4-bis(4-hydroxy phenyl)heptane, 1,1-bis(2-tert-butyl-4-hydroxy-5-methyl phenyl)heptane, 2,2-bis(4-hydroxy phenyl)octane, 1,1-(4-hydroxy phenyl)ethane, and the like, and combinations thereof.

Examples of the bis(hydroxy aryl)cycloalkanes may include without limitation 1,1-bis(4-hydroxy phenyl)cyclopentane, 1,1-bis(4-hydroxy phenyl)cyclohexane, 1,1-bis(3-methyl-4-hydroxy phenyl)cyclohexane, 1,1-bis(3-cyclo hexyl-4-hydroxy phenyl)cyclohexane, 1,1-bis(3-phenyl-4-hydroxy phenyl)cyclohexane, 1,1-bis(4-hydroxy phenyl)-3,5,5-trimethylcyclohexane, and the like, and combinations thereof.

Examples of the bis(hydroxy aryl)ethers may include without limitation bis(4-hydroxy phenyl)ether, bis(4-hydroxy-3-methyl phenyl)ether, and the like, and combinations thereof.

Examples of the bis(hydroxy aryl)sulfides may include without limitation bis(4-hydroxy phenyl)sulfide, bis(3-methyl-4-hydroxy phenyl)sulfide, and the like, and combinations thereof.

Examples of the bis(hydroxy aryl)sulfoxides may include without limitation bis(hydroxy phenyl)sulfoxide, bis(3-methyl-4-hydroxy phenyl)sulfoxide, bis(3-phenyl-4-hydroxy phenyl)sulfoxide, and the like, and combinations thereof.

Examples of the biphenyl compounds may include without limitation bis(hydroxy aryl)sulfones such as bis(4-hydroxy phenyl)sulfone, bis(3-methyl-4-hydroxy phenyl)sulfone, bis(3-phenyl-4-hydroxy phenyl)sulfone, and the like, 4,4′-dihydroxy biphenyl, 4,4′-dihydroxy-2,2′-dimethylbiphenyl, 4,4′-dihydroxy-3,3′-dimethylbiphenyl, 4,4′-dihydroxy-3,3′-dicyclobiphenyl, 3,3-difluoro-4,4′-dihydroxybiphenyl, and the like, and combinations thereof.

Examples of other aromatic dihydroxy compounds (a1) which may be used in addition to the compounds represented by Chemical Formula 1 can include without limitation dihydroxy benzene, halogen and/or C₁-C₁₀ alkyl-substituted dihydroxy benzene, and the like, and combinations thereof. Examples of other aromatic dihydroxy compounds (a1) may include without limitation resorcinol, 3-methylresorcinol, 3-ethylresorcinol, 3-propylresorcinol, 3-butyl resorcinol, 3-tert-butyl resorcinol, 3-phenylresorcinol, 2,3,4,6-tetrafluororesorcinol, 2,3,4,6-tetrabromoresorcinol, catechol, hydroquinone, 3-methylhydroquinone, 3-ethylhydroquinone, 3-propylhydroquinone, 3-butylhydroquinone, 3-tert-butylhydroquinone, 3-phenylhydroquinone, 3-cumylhydroquinone, 2,5-dichlorohydroquinone, 2,3,5,6-tetramethylhydroquinone, 2,3,5,6-tetra-tert-butylhydroquinone, 2,3,5,6-tetrafluorohydroquinone, 2,3,5,6-tetrabromo hydroquinone, and the like, and combinations thereof.

In exemplary embodiments, 2,2-bis(4-hydroxy phenyl)propane (bisphenol A) can be used as the aromatic dihydroxy compound (a1).

(a2) Carbonate Precursor

Examples of the carbonate precursor may include without limitation dimethyl carbonate, diethyl carbonate, dibutyl carbonate, dicyclohexyl carbonate, diphenyl carbonate, ditolyl carbonate, bis(chlorophenyl)carbonate, m-cresyl carbonate, dinaphthyl carbonate, bis(diphenyl)carbonate, carbonyl chloride (phosgene), triphosgene, diphosgene, carbonyl bromide, bishaloformate, and the like. These compounds may be used alone or in combination of two or more thereof.

When a polycarbonate resin is prepared by interfacial polymerization, the carbonyl chloride (phosgene) may be used.

The carbonate precursor (a2) may be used in a molar ratio of about 0.9 to about 1.5 moles based on about 1 mole of the aromatic dihydroxy compound (a1).

The polycarbonate resin composition for carrier tapes can include the polycarbonate resin (A) in an amount of about 50 to about 97% by weight, for example about 60 to about 97% by weight, based on 100% by weight of a base resin comprising the polycarbonate resin (A) and the rubber-modified aromatic vinyl resin (B1), the semi-crystalline polymer resin (B2) or a mixture thereof (B). In some embodiments, the polycarbonate resin composition for carrier tapes can include the polycarbonate resin (A) in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, or 97% by weight. Further, according to some embodiments of the present invention, the polycarbonate resin (A) may be present in an amount of from about any of the foregoing amounts to about any other of the foregoing amounts.

When the amount of the polycarbonate resin (A) is less than about 50% by weight, the polycarbonate resin composition can have deteriorated heat resistance and rheological properties. When the amount of the polycarbonate resin (A) is more than about 97% by weight, the polycarbonate resin composition can have deteriorated sheet productivity and physical properties.

(B) Rubber-Modified Aromatic Vinyl Resin (B1), Semi-Crystalline Polymer Resin (B2) or a Mixture Thereof (B1) Rubber-Modified Aromatic Vinyl Resin

Examples of the rubber-modified aromatic vinyl resin may comprise without limitation an acrylonitrile-butadiene-styrene copolymer resin (b1), a styrene-ethylene-butadiene-styrene copolymer resin (b2) and mixtures thereof.

(b1) Acrylonitrile-Butadiene-Styrene Copolymer Resin (ABS Resin)

The acrylonitrile-butadiene-styrene copolymer resin (b1) can comprise a styrene-acrylonitrile-containing graft copolymer resin (b1a); or a styrene-acrylonitrile-containing graft copolymer resin (b1a) and a styrene-acrylonitrile-containing copolymer resin (b1b). The acrylonitrile-butadiene-styrene copolymer resin (b1) used in this invention can be prepared by using g-ABS; or g-ABS and SAN in a proper content ratio, which can be mixed taking into consideration their compatibility.

(b1a) Styrene-Acrylonitrile-Containing Graft Copolymer Resin (g-ABS)

The styrene-acrylonitrile-containing graft copolymer resin (b1a) can be obtained by graft copolymerizing an aromatic vinyl monomer and a monomer which can be copolymerized with the aromatic vinyl monomer onto a rubber polymer, and may further comprise a monomer which provides processibility and heat resistance as needed.

Examples of the rubber polymer can include without limitation diene rubbers such as polybutadiene, poly(styrene-butadiene), poly(acrylonitrile-butadiene), and the like, saturated rubbers with hydrogen added to the diene rubber, isoprene rubbers, acrylic-based rubbers such as a polybutyl acrylic acid based rubbers, ethylene-propylene-diene monomer terpolymers (EPDM), and the like, and combinations thereof. In exemplary embodiments, the rubber polymer can include a diene rubber, for example butadiene rubber.

The styrene-acrylonitrile-containing graft copolymer resin (b1a) can include the rubber polymer in an amount of about 5 to about 65% by weight, based on the total weight (100% by weight) of the graft copolymer resin (b1a), for example about 10 to about 60% by weight, and as another example about 20 to about 50% by weight. In some embodiments, the styrene-acrylonitrile-containing graft copolymer resin (b1a) can include the rubber polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65% by weight. Further, according to some embodiments of the present invention, the rubber polymer may be present in an amount of from about any of the foregoing amounts to about any other of the foregoing amounts.

When the styrene-acrylonitrile-containing graft copolymer resin (b1a) includes the rubber polymer in an amount within the above range, the copolymer can have a balance of impact strength and mechanical properties.

The rubber polymer (rubber particle) can have an average particle size (Z-average) of about 0.05 to about 6 μm, for example about 0.15 to about 4 μm, and as another example about 0.25 to about 3.5 μm. Impact strength and external appearance can be excellent within the above ranges.

The aromatic vinyl monomer can be graft copolymerized onto the rubber polymer. Examples thereof can include, but are not limited to, styrene, α-methylstyrene, β-methylstyrene, p-methylstyrene, para-t-butylstyrene, ethylstyrene, vinylxylene, monochlorostyrene, dichlorostyrene, dibromostyrene, vinylnaphthalene, and the like, and combinations thereof. Styrene can be used in exemplary embodiments.

The styrene-acrylonitrile-containing graft copolymer resin (b1a) can include the aromatic vinyl monomer in an amount of about 15 to about 94% by weight, based on the total weight (100% by weight) of the graft copolymer resin (b1a), for example, about 20 to about 80% by weight, and as another example about 30 to about 60% by weight. In some embodiments, the styrene-acrylonitrile-containing graft copolymer resin (b1a) can include the aromatic vinyl monomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94% by weight. Further, according to some embodiments of the present invention, the aromatic vinyl monomer may be present in an amount of from about any of the foregoing amounts to about any other of the foregoing amounts.

When the styrene-acrylonitrile-containing graft copolymer resin (b1a) includes the aromatic vinyl monomer in an amount within the above range, the graft copolymer can have a balance of impact strength and mechanical properties.

Examples of the monomer which can be copolymerized with the aromatic vinyl monomer can include without limitation vinyl cyanide compounds such as acrylonitrile and the like; unsaturated nitrile compounds such as ethacrylonitrile, methacrylonitrile, and the like, and these compounds may be used alone or in combination of two or more thereof.

The styrene-acrylonitrile-containing graft copolymer resin (b1a) can include the monomer which can be copolymerized with the aromatic vinyl monomer in an amount of about 1 to about 50% by weight, based on the total weight (100% by weight) of the graft copolymer resin (b1), for example about 5 to about 45% by weight, and as another example about 10 to about 30% by weight. In some embodiments, the styrene-acrylonitrile-containing graft copolymer resin (b1a) can include the monomer which can be copolymerized with the aromatic vinyl monomer in an amount of about 1, 2, 3, 4, 5, 6, 7, 8, 9, 10, 11, 12, 13, 14, 15, 16, 17, 18, 19, 20, 21.22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the monomer which can be copolymerized with the aromatic vinyl monomer may be present in an amount of from about any of the foregoing amounts to about any other of the foregoing amounts.

When the styrene-acrylonitrile-containing graft copolymer resin (b1a) includes the monomer which can be copolymerized with the aromatic vinyl monomer in an amount within the above range, the graft copolymer can have a balance of impact strength and mechanical properties within the above ranges.

Examples of the monomer which provides processibility and heat resistance can include without limitation acrylic acid, methacrylic acid, maleic anhydride, N-substituted maleimide, and the like, and combinations thereof.

The styrene-acrylonitrile-containing graft copolymer resin (b1a) can include the monomer which provides processibility and heat resistance in an amount of 0 to about 15% by weight, based on the total weight (100% by weight) of the graft copolymer resin (b1a), for example about 0.1 to about 10% by weight. In some embodiments, the styrene-acrylonitrile-containing graft copolymer resin (b1a) can include the monomer which provides processibility and heat resistance in an amount of 0 (the monomer is not present), about 0 (the monomer is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15% by weight. Further, according to some embodiments of the present invention, the monomer which provides processibility and heat resistance may be present in an amount of from about any of the foregoing amounts to about any other of the foregoing amounts.

When the styrene-acrylonitrile-containing graft copolymer resin (b1a) includes the monomer which provides processibility and heat resistance in an amount within the above range, processibility and heat resistance can be provided without deteriorating other properties.

(b1b) Styrene-Acrylonitrile-Containing Copolymer Resin (SAN)

The styrene-acrylonitrile-containing copolymer resin used in this invention can be prepared by using a monomer mixture including the components described above with respect to the graft copolymer resin (b1a), except for rubber (rubber polymer), and the ratio of the monomers may be different depending on compatibility. For example, the copolymer resin (b1b) can be obtained by copolymerizing the aromatic vinyl monomer and the monomer copolymerizable with the aromatic vinyl monomer.

Examples of the aromatic vinyl monomer can include, but are not limited to, styrene, α-methylstyrene, β-methylstyrene, p-methylstyrene, para-t-butylstyrene, ethylstyrene, vinylxylene, monochlorostyrene, dichlorostyrene, dibromostyrene, vinylnaphthalene, and the like, and combinations thereof. In exemplary embodiments, styrene can be used.

Examples of the monomer which can be copolymerized with the aromatic vinyl monomer can include without limitation vinyl cyanide compounds such as acrylonitrile; unsaturated nitrile compounds such as ethacrylonitrile and methacrylonitrile, and the like, and these can be used alone or in combination of two or more thereof.

The copolymer resin (b1b) may further comprise a monomer which provides processibility and heat resistance as needed. Examples of the monomer which provides processibility and heat resistance can include, but are not limited to, acrylic acid, methacrylic acid, maleic anhydride, N-substituted maleimide, and the like, and combinations thereof.

The copolymer resin (b1b) can include the aromatic vinyl monomer in an amount of about 50 to about 95% by weight, based on the total weight (100% by weight) of the copolymer resin (b1b), for example about 60 to about 90% by weight, and as another example about 70 to about 80% by weight. In some embodiments, the copolymer resin (b1b) can include the aromatic vinyl monomer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95% by weight. Further, according to some embodiments of the present invention, the aromatic vinyl monomer may be present in an amount of from about any of the foregoing amounts to about any other of the foregoing amounts.

When the copolymer resin (b1b) includes the aromatic vinyl monomer in an amount within the above range, the copolymer can have a balance of impact strength and mechanical properties.

The copolymer resin (b1b) can include the monomer which can be copolymerized with the aromatic vinyl monomer in an amount of about 5 to about 50% by weight, based on the total weight (100% by weight) of the copolymer resin (b1b), for example about 10 to about 40% by weight, and as another example about 20 to about 30% by weight. In some embodiments, the copolymer resin (b1b) can include the monomer which can be copolymerized with the aromatic vinyl monomer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the monomer which can be copolymerized with the aromatic vinyl monomer may be present in an amount of from about any of the foregoing amounts to about any other of the foregoing amounts.

When the copolymer resin (b1b) includes the monomer which can be copolymerized with the aromatic vinyl monomer in an amount within the above range, the copolymer can have a balance of impact strength and mechanical properties.

Further, the copolymer resin (b1b) may comprise a monomer which provides processibility and heat resistance in an amount of 0 to about 20% by weight, based on the total weight (100% by weight) of the copolymer resin (b1b), for example about 0.1 to about 20% by weight. In some embodiments, the copolymer resin (b1b) may comprise a monomer which provides processibility and heat resistance in an amount of 0 (the monomer is not present), about 0 (the monomer is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20% by weight. Further, according to some embodiments of the present invention, the monomer which provides processibility and heat resistance may be present in an amount of from about any of the foregoing amounts to about any other of the foregoing amounts.

When the copolymer resin (b1b) includes the monomer which provides processibility and heat resistance in an amount within the above range, the copolymer can have processibility and heat resistance with minimal or no deterioration of other properties.

The copolymer resin (b1b) may have a weight-average molecular weight of, but is not limited thereto, about 50,000 to about 500,000 g/mol.

A method for preparing the copolymer resin can be well known to those skilled in the art, and any one of emulsion polymerization, suspension polymerization, solution polymerization, or mass-polymerization may be used.

(b2) Styrene-Ethylene-Butylene-Styrene Copolymer Resin (SEBS Resin)

As the styrene-ethylene-butylene-styrene copolymer resin (b2) of the present invention, commercially available products may be used without limitation. The styrene-ethylene-butylene-styrene copolymer resin (b2) is an A-B-A′ type block copolymer resin. The A and A′ blocks are hard segments, and the B block is a soft segment. The hard segment prevents thermoplastic modification, and the soft segment exhibits rubber properties. A styrene polymer can be used as the A and A′ blocks, and ethylene-butadiene can be used as the B block.

The styrene-ethylene-butylene-styrene copolymer resin (b2) can comprise styrene polymer in an amount of about 20 to about 35% by weight and ethylene-butadiene in an amount of about 65 to about 80% by weight, for example can comprise the styrene polymer in an amount of about 27 to about 35% by weight and the ethylene-butadiene in an amount of about 65 to about 73% by weight.

In some embodiments, the styrene-ethylene-butylene-styrene copolymer resin (b2) can comprise styrene polymer in an amount of about 20, 21, 22, 23, 24, 25, 26, 27, 28, 29, 30, 31, 32, 33, 34, or 35% by weight. Further, according to some embodiments of the present invention, the styrene polymer may be present in an amount of from about any of the foregoing amounts to about any other of the foregoing amounts.

In some embodiments, the styrene-ethylene-butylene-styrene copolymer resin (b2) can comprise ethylene-butadiene in an amount of about 65, 66, 67, 68, 69, 70, 71, 72, 73, 74, 75, 76, 77, 78, 79, or 80% by weight. Further, according to some embodiments of the present invention, the ethylene-butadiene may be present in an amount of from about any of the foregoing amounts to about any other of the foregoing amounts.

The styrene-ethylene-butylene-styrene copolymer resin (b2) can have a weight-average molecular weight of about 140,000 to about 180,000 g/mol, for example about 147,000 to about 170,000 g/mol. When the styrene-ethylene-butylene-styrene copolymer resin (b2) has a weight-average molecular weight within the above ranges, tensile strength can be excellent at a low surface hardness.

The base resin can include the rubber-modified aromatic vinyl resin (B1) in an amount of about 3 to about 50% by weight, for example about 3 to about 25% by weight, based on 100% by weight of the base resin. In some embodiments, the base resin can include the rubber-modified aromatic vinyl resin (B1) in an amount of about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the rubber-modified aromatic vinyl resin (B1) may be present in an amount of from about any of the foregoing amounts to about any other of the foregoing amounts.

When the amount of the rubber-modified aromatic vinyl resin (B1) is less than about 3% by weight, a polycarbonate resin composition can have deteriorated physical properties and productivity. When the amount of the rubber-modified aromatic vinyl resin (B1) is more than about 50% by weight, a polycarbonate resin composition can have deteriorated heat resistance and external appearance.

(B2) Semi-Crystalline Polymer Resin

In this invention, the semi-crystalline polymer resin (B2) can comprise a polyalkylene terephthalate resin (b3), an ethylene vinyl acetate resin (b4) or a combination thereof. In this invention, the polycarbonate resin (A) is uncrystallized, and thus does not flow easily. Using the semi-crystalline polymer resin (B2) having liquidity can improve the dispersibility of carbon nanotubes (C), which then can result in excellent conductivity.

(b3) Polyalkylene Terephthalate Resin

As the semi-crystalline polymer resin (B2), a polyalkylene terephthalate resin (b3), which is a polyester resin may be used. Examples of the polyalkylene terephthalate resin (b3) can include without limitation polyethylene terephthalate resin (PET), polycyclohexanedimethylene terephthalate (PCT), polybutylene terephthalate (PBT), polytrimethylene terephthalate (PTT), and the like, and combinations thereof. In exemplary embodiments, polybutylene terephthalate resin (PBT) and/or polyethylene terephthalate resin (PET) can be used.

The polyalkylene terephthalate resin (b3) can be prepared by polymerizing a dicarbonic acid component including terephthalic acid and a diol component. The dicarbonic acid component can include other dicarbonic acids in addition to terephthalic acid.

Examples of dicarbonic acids can include without limitation terephthalic acid, isophthalic acid, a naphthalene dicarbonic acid, a diphenylether dicarboxylic acid, a diphenyl dicarboxylic acid, a diphenylsulfone dicarboxylic acid, and the like, and combinations thereof.

As the component of the diol, α,ω-diol can be used, and examples thereof can include without limitation trimethylene glycol, tetramethylene glycol, hexamethylene glycol, neopentyl glycol, cyclohexane dimethylol, 2,2-bis(4-βhydroxyphenyl-phenyl)propane, 4,4-bis(β-hydroxyepoxy)diphenyl sulfone, diethylene glycol and the like, and combinations thereof.

As a non-limiting example, polybutylene terephthalate resin (PBT) can used. PBT can be prepared using methods known in the art, including directly carrying out an etherification reaction of 1,4-butanediol with a terephthalic acid or dimethylterephthalate, or by carrying out a transesterification reaction.

In order to improve the impact strength of the polybutylene terephthalate resin, a copolymer wherein the polybutylene terephthalate is copolymerized with impulse strength-improving components such as polytetramethylene glycol (PTMG), polyethylene glycol (PEG), polypropylene glycol (PPG), an aliphatic polyester, an aliphatic polyamide, and the like, or modified polybutylene terephthalate blended with the above impulse strength improving components, may be used.

The polybutylene terephthalate resin may have an intrinsic viscosity [η] of about 0.36 dl/g to about 1.60 dl/g, for example about 0.52 dl/g to about 1.25 dl/g, measured in accordance with ASTM D2857. When the intrinsic viscosity of the PBT resin is within the above range, the PBT resin may exhibit an excellent property balance between mechanical properties and formability.

The polyethylene terephthalate resin (PET) may also be prepared using methods known in the art, including polymerizing terephthalic acid or dimethylterephthalate and ethylene glycol.

(b4) Ethylene Vinyl Acetate Resin (EVA)

As the ethylene vinyl acetate resin (b4) of the present invention, commercially available products may be used without limitation. The ethylene vinyl acetate resin (b4) can be a polymer obtained by copolymerizing ethylene and a vinyl acetate monomer, and can be a semi-crystalline polymer resin.

The physical property of the ethylene vinyl acetate resin (b4) can be determined by the degree of polymerization and the amount of vinyl acetate. The higher the molecular weight, the better robustness, plasticity, stress cracking resistance and impact resistance, and the worse formability or surface gloss. Increasing the amount of the vinyl acetate increases density, but decreases the degree of crystallization, which leads to an increase in flexibility.

The ethylene vinyl acetate resin (b4) used in the present invention can include the vinyl acetate in an amount of about 5 to about 20% by weight. In some embodiments, the ethylene vinyl acetate resin (b4) can include vinyl acetate in an amount of about 5, 6, 7, 8, 9, 10, 11, 12, 13, 14, 15, 16, 17, 18, 19, or 20% by weight. Further, according to some embodiments of the present invention, the vinyl acetate may be present in an amount of from about any of the foregoing amounts to about any other of the foregoing amounts.

When the ethylene vinyl acetate resin (b4) includes the vinyl acetate in an amount within the above range, the ethylene vinyl acetate resin (b4) can have excellent flexibility, which can improve the dispersibility of carbon nanotubes (C).

The base resin can include the semi-crystalline polymer resin (B2) in an amount of about 3 to about 50% by weight, for example about 5 to about 25% by weight, based on 100% by weight of the base resin. In some embodiments, the base resin can include the semi-crystalline polymer resin (B2) in an amount of about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the semi-crystalline polymer resin (B2) may be present in an amount of from about any of the foregoing amounts to about any other of the foregoing amounts.

When the amount of the semi-crystalline polymer resin (B2) is less than about 3% by weight, external appearance and productivity can be deteriorated. When the amount of the semi-crystalline polymer resin (B2) is more than about 50% by weight, a polycarbonate resin composition sheet for carrier tapes can have deteriorated external appearance and degree of thickness uniformity.

In another embodiment of the present invention, a mixture of the rubber-modified aromatic vinyl resin (B1) and the semi-crystalline polymer resin (B2) may be used, wherein the base resin can include the mixture in an amount of about 3 to about 50% by weight, based on 100% by weight of the base resin. In some embodiments, the base resin can include the mixture of the rubber-modified aromatic vinyl resin (B1) and the semi-crystalline polymer resin (B2) in an amount of about 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the mixture of the rubber-modified aromatic vinyl resin (B1) and the semi-crystalline polymer resin (B2) may be present in an amount of from about any of the foregoing amounts to about any other of the foregoing amounts.

In this case, the mixture of the rubber-modified aromatic vinyl resin (B1) and the semi-crystalline polymer resin (B2) may comprise about 20 to about 80% by weight of the rubber-modified aromatic vinyl resin (B1) and about 20 to about 80% by weight of the semi-crystalline polymer resin (B2).

In some embodiments, the mixture of the rubber-modified aromatic vinyl resin (B1) and the semi-crystalline polymer resin (B2) can include the rubber-modified aromatic vinyl resin (B1) in an amount of about 20, 21, 22, 23, 24, 25, 26, 27, 28, 29, 30, 31, 32, 33, 34, 35, 36, 37, 38, 39, 40, 41.42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight.

Further, according to some embodiments of the present invention, the rubber-modified aromatic vinyl resin (B1) may be present in an amount of from about any of the foregoing amounts to about any other of the foregoing amounts.

In some embodiments, the mixture of the rubber-modified aromatic vinyl resin (B1) and the semi-crystalline polymer resin (B2) can include the semi-crystalline polymer resin (B2) in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight. Further, according to some embodiments of the present invention, the semi-crystalline polymer resin (B2) may be present in an amount of from about any of the foregoing amounts to about any other of the foregoing amounts.

When the rubber-modified aromatic vinyl resin (B1) and the semi-crystalline polymer resin (B2) are used together within the above range, a polycarbonate resin composition for carrier tapes can have a surface resistance of about 10⁵Ω/□ or less, and have excellent external appearance and productivity.

(C) Carbon Nanotubes

The present invention uses carbon nanotubes (C) to maintain impact resistance and obtain electric conductivity. The mechanical features of the carbon nanotubes are to have high mechanical strength and Young's Modulus, and have a high aspect ratio. Further, the carbon nanotubes have high electric conductivity and thermostability.

The polycarbonate resin composition for carrier tapes according to the present invention uses the rubber-modified aromatic vinyl resin (B1) and/or the semi-crystalline polymer resin (B2) having liquidity to improve the dispersibility of the carbon nanotubes (C). Thus, the present invention uses a small amount of carbon nanotubes with excellent conductivity compared to the existing carbon black, and thus generates less dust compared to the conventional resin for conductive sheets so that there is less pollution from dust.

A method for synthesizing carbon nanotubes can include an arc-discharge method, a pyrolysis method, a laser vaporization method, a plasma chemical vapor deposition method, a thermal chemical vapor deposition method, an electrolytic method, a flame synthesis method, and the like. However, any obtained carbon nanotubes may be used as the carbon nanotubes (C) used in the present invention regardless of synthesizing methods.

Depending on the number of walls of carbon nanotubes, carbon nanotubes can be classified into single-wall carbon nanotubes, double-wall carbon nanotubes, multi-wall carbon nanotubes, and cup-stacked carbon nanofibers, wherein truncated cone-shaped graphenes are multi-layered to have a hollow tube shape. The kind of the carbon nanotubes (C) used in the present invention is not limited. In exemplary embodiments, multi-wall carbon nanotubes can be used.

The carbon nanotubes (C) can have an average diameter of about 0.5 to about 100 nm, for example about 1 to about 20 nm, and may have an average length of about 0.005 to about 100 μm, for example about 1 μm to about 50 μm.

The carbon nanotubes (C) can have an aspect ratio (L/D) of about 500 to about 5,000. When the aspect ratio of the carbon nanotubes (C) is less than about 500, it can be difficult to form an electrical structure to implement conductivity in the polycarbonate resin composition. When the aspect ratio of the carbon nanotubes (C) is more than about 5,000, synthesis of the carbon nanotubes can take a long time, which can increase cost.

The polycarbonate resin composition can include the carbon nanotubes (C) in an amount of about 0.5 to about 5 parts by weight, for example about 0.5 to about 3 parts by weight, per about 100 parts by weight of a base resin including the polycarbonate resin (A), the rubber-modified aromatic vinyl resin (B1) and/or the semi-crystalline polymer resin (B2). In some embodiments, the polycarbonate resin composition can include the carbon nanotubes (C) in an amount about 0.5, 0.6, 0.7, 0.8, 0.9, 1, 2, 3, 4, or 5 parts by weight. Further, according to some embodiments of the present invention, the carbon nanotubes (C) may be present in an amount of from about any of the foregoing amounts to about any other of the foregoing amounts.

When the amount of the carbon nanotubes (C) is less than about 0.5 parts by weight, tensile strength and tensile elongation cannot be maintained, and electric conductivity can be also deteriorated. When the amount of the carbon nanotubes (C) is more than about 5 parts by weight, flexibility can be deteriorated, and external appearance may not be smooth due to cohesion of the carbon nanotubes.

(D) Additives

The polycarbonate resin composition of the present invention may further comprise one or more additives according to its use. Examples of the additives may include, but are not limited to, waxes, antioxidants, antimicrobial agents, thermal stabilizers, release agents, photostabilizers, inorganic additives, surfactants, coupling agents, plasticizers, compatibilizers, lubricants, antistatic agents, colorants, such as pigments and/or dyes, flame-retardants, flame retardant supplements, drip preventive agents, weatherability stabilizers, UV absorbers, sunscreen agents, and the like, and combinations thereof.

Examples of the antioxidant can include without limitation phenol-type antioxidants, phosphite-type antioxidants, thioether-type antioxidants, amine-type antioxidants, and the like, and combinations thereof.

Examples of the release agent can include without limitation fluorine-containing polymers, silicone oils, stearic acid metallic salts, montanic acid metallic salts, montanic acid ester waxes, polyethylene waxes and the like, and combinations thereof.

Examples of the inorganic additives can include without limitation glass fibers, carbon fibers, silica, mica, alumina, clay, calcium carbonate, calcium sulfate, glass beads, and the like, and combinations thereof.

Examples of the flame-retardant can include without limitation phosphorus flame-retardants, nitrogen flame-retardants, halogen flame-retardants, and the like, and combinations thereof. Examples of the flame retardant supplements can include without limitation antimony oxide, and the like, and combinations thereof.

Examples of the drip preventive agents can include without limitation polytetrafluoroethylene and the like, and combinations thereof.

Examples of the weatherability stabilizers can include without limitation benzophenone-type weatherability stabilizers, amine-type weatherability stabilizers and the like, and combinations thereof.

The additives (D) of the present invention may be included in an amount of about 0.1 to about 5 parts by weight, based on about 100 parts by weight of the base resin comprising the polycarbonate resin (A), the rubber-modified aromatic vinyl resin (B1) and/or the semi-crystalline polymer resin (B2). When the additives are included in an amount the above range, the effect of the additives according to their use can be obtained, and excellent mechanical properties and enhanced surface appearance can also be obtained.

The polycarbonate resin composition for carrier tapes according to the present invention may be prepared by a conventional method for preparing a resin composition. For example, the composition can be prepared in a pellet or a chip form by mixing the aforementioned components of the present invention with the optional additives and then melt extruding the mixture in an extruder.

The polycarbonate resin composition for carrier tapes of the present invention may have a surface resistance of about 10⁴ to about 10⁵Ω/□ measured in accordance with ASTM D257, for example the surface resistance may be about 10⁴Ω/□ or about 10^{5Ω/□.}

The polycarbonate resin composition of the present invention may have a productivity of about 6.8 to about 8.5 m/min measured in accordance with a production evaluation of a 120 mm (width)×0.4 mm (thickness) sheet, for example, the productivity may be 6.9, 7.2, 7.3, 7.5, 7.8, 7.9, 8.0 or 8.1 m/min.

The polycarbonate resin composition of the present invention may have a sheet thickness variation of less than about 1% measured on a 120 mm (width)×0.4 mm (thickness) sheet.

The polycarbonate resin composition of the present invention may have a tensile strength of about 480 to about 660 kgf/cm² measured for a specimen having a size of 120 mm (width)×0.4 mm (thickness) in accordance with ASTM D 638, for example, the tensile strength may be about 490, about 520, about 600, about 620, about 625, about 627, about 630, about 640, about 650, or about 657 kgf/cm².

The polycarbonate resin composition of the present invention may have a tensile elongation of about 55 to about 120% measured for a specimen having a size of 120 mm (width)×0.4 mm (thickness) in accordance with ASTM D 638, for example, the tensile elongation may be about 57, about 68, about 72, about 74, about 80, about 82, about 84, about 100, about 110, or about 115%.

The polycarbonate resin composition for carrier tapes according to the present invention can generate little dust, and can be applied to molded articles which require enhanced electric conductivity, productivity, tensile strength and/or tensile elongation. For examples, it can be applied to carrier tapes, reel tapes, and the like.

The present invention further provides a molded article produced from the polycarbonate resin composition for carrier tapes. A method for molding the molded article is not particularly limited, but extrusion molding, injection molding, blow molding, compression molding or casting molding may be used. These molding methods can be easily carried out by those skilled in the art.

The present invention will be further defined in the following examples, which are intended for the purpose of illustration and are not to be construed as in any way limiting the scope of the present invention.

### EXAMPLES

The particulars of each component used in Examples and Comparative Examples of the present invention are as follows:
(A) Polycarbonate resin
   PANLITE L 1225WX manufactured by TEIJIN CHEMICALS LTD is used.
(B1) Rubber-modified aromatic vinyl resin
   (b1) ABS resin
      CHTS manufactured by Cheil Industries Inc is used.
   (b2) SEBS resin
      KRATON G1651, SHELL
(B2) Semi-crystalline polymer Resin
   (b3) Polybutylene terephthalate (PBT)
      Shinite K001 manufactured by SHINKONG is used.
   (b4) Ethylene vinyl acetate (EVA)
      Elvax® 150 manufactured by Dupont is used
(C) Carbon nanotubes
Multi-wall carbon nanotubes having an aspect ratio of 500 to 2,000 are used.
(D) Additives
Wax: Licowax PED 191, Clariant
Antioxidant: IRGANOX 1076, CIBA

### Examples 1-13 and Comparative Examples 1-8

Each of the components is dry mixed in the amounts as illustrated in Tables 1 and 2, and the mixture is then extruded using a twin-screw extruder (L/D=35, Φ=45 mm) to prepare the extruded mixture in pellets. The prepared pellets are injected using a 10 oz injection machine at 280° C. to prepare test specimen to measure various physical properties.

In Tables 1 and 2, the mixture ratio of (A), (B) and (C) are expressed in % by weight of each component, based on 100% by weight of (A) and (B), and (C) is expressed in parts by weight, based on 100 parts by weight of (A)+(B).

TABLE 1

| | | Examples | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| (A) | | 80 | 80 | 80 | 80 | 60 | 95 | 95 | 90 | 95 | 60 | 90 | 97 | 80 |
| (B1) | (b1) | 20 | — | — | — | 40 | 5 | — | 10 | — | 20 | — | 1 | 10 |
| | (b2) | — | — | 20 | — | — | — | — | — | — | — | 5 | — | — |
| (B2) | (b3) | — | 20 | — | — | — | — | 5 | — | — | 20 | — | 2 | 10 |
| | (b4) | — | — | — | 20 | — | — | — | — | 10 | — | 5 | — | — |

| | | | | | | | | | | | | | |
|---|---|---|---|---|---|---|---|---|---|---|---|---|---|
| (C) | 1.0 | 1.0 | 1.0 | 1.0 | 1.0 | 1.0 | 1.0 | 1.0 | 1.0 | 1.0 | 1.0 | 1.0 | 1.0 |
| (D) | 0.5 | 0.5 | 0.5 | 0.5 | 0.5 | 0.5 | 0.5 | 0.5 | 0.5 | 0.5 | 0.5 | 0.5 | 0.5 |

TABLE 2

| | | Comparative Examples | | | | | | | |
|---|---|---|---|---|---|---|---|---|---|
| | | 1 | 2 | 3 | 4 | 5 | 6 | 7 | 8 |
| (A) | | 100 | 40 | — | — | — | 98 | 90 | 90 |
| (B1) | (b1) | — | — | 100 | — | — | 2 | — | — |
| | (b2) | — | — | — | — | — | — | — | 10 |
| (B2) | (b3) | — | 60 | — | 100 | — | — | 10 | — |
| | (b4) | — | — | — | — | 100 | — | — | — |

| | | | | | | | | |
|---|---|---|---|---|---|---|---|---|
| (C) | 1.0 | 1.0 | 1.0 | 1.0 | 1.0 | 1.0 | 6.0 | 6.0 |
| (D) | 0.5 | 0.5 | 0.5 | 0.5 | 0.5 | 0.5 | 0.5 | 0.5 |

The physical properties of the prepared test samples are measured by the following methods, and the results are presented in Tables 3 and 4 below.

Method for Measuring Physical Properties
(1) Surface resistance (Ω/□) is measured using SRM-100 made by Wolfgang Warmbier GmbH & Co. KG in accordance with ASTM D 257.
(2) Productivity (m/min) is measured using a sheet having a size of 120 mm (width)×0.4 mm (thickness).
(3) Sheet thickness variation (%) is measured using a sheet having a size of 120 mm (width)×0.4 mm (thickness).
(4) Tensile strength is measured in accordance with ASTM D 638.
(5) Tensile elongation is measured using a test specimen having a size of 120 mm (width)×0.4 mm (thickness) in accordance with ASTM D 638.

TABLE 3

| | Examples | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Surface | 10⁴ | 10⁴ | 10⁵ | 10⁵ | 10⁵ | 10⁵ | 10⁵ | 10⁵ | 10⁵ | 10⁴ | 10⁴ | 10⁴ | 10⁴ |
| resistance | | | | | | | | | | | | | |
| Productivity | 7.2 | 8.1 | 7.3 | 7.8 | 7.9 | 7.8 | 7.9 | 7.8 | 8.0 | 7.8 | 6.9 | 7.2 | 7.5 |
| Sheet | <1 | <1 | <1 | <1 | <1 | <1 | <1 | <1 | <1 | <1 | <1 | <1 | <1 |
| thickness | | | | | | | | | | | | | |
| variation | | | | | | | | | | | | | |
| Tensile | 620 | 490 | 630 | 520 | 640 | 650 | 630 | 625 | 627 | 600 | 620 | 657 | 630 |
| strength | | | | | | | | | | | | | |
| Tensile | 100 | 57 | 110 | 74 | 115 | 80 | 74 | 84 | 72 | 68 | 72 | 82 | 80 |
| elongation | | | | | | | | | | | | | |

TABLE 4

| | Comparative Examples | | | | | | | |
|---|---|---|---|---|---|---|---|---|
| | 1 | 2 | 3 | 4 | 5 | 6 | 7 | 8 |
| Surface | 10⁴ | 10⁴ | 10⁸ | 10⁴ | 10⁵ | 10⁵ | 10² | 10² |
| resistance | | | | | | | | |
| Productivity | 5.5 | 10.7 | 11.4 | 19.7 | 13.0 | 6.0 | 2.1 | 2.3 |
| Sheet | <1 | <6 | <2 | <8 | <4 | <1 | <8 | <8 |
| thickness | | | | | | | | |
| variation | | | | | | | | |
| Tensile | 500 | 420 | 780 | 440 | 470 | 520 | 320 | 280 |
| strength | | | | | | | | |
| Tensile | 70 | 32 | 21 | 38 | 42 | 72 | 21 | 25 |
| elongation | | | | | | | | |

As shown in the results presented in Tables 3 and 4, the polycarbonate resin compositions for carrier tapes illustrated in Examples 1-13 in accordance with the present invention can have a surface resistance of 10⁵Ω/□ or less, and have superior electric conductivity, productivity, tensile strength and tensile elongation.

In contrast, Comparative Example 1, which does not use (B), exhibits decreased productivity. Comparative Example 2, which uses (A) and (B) in amounts outside of the ranges of the present invention, exhibits increased sheet thickness variation and decreased tensile strength and tensile elongation. Comparative Example 3, which does not use (A), exhibits increased surface resistance and sheet thickness variation. Comparative Examples 4 and 5 exhibit increased sheet thickness variation and decreased tensile strength and tensile elongation. Comparative Example 6 exhibits decreased productivity. Comparative Examples 7 and 8, which use (C) in amounts outside of the range of the present invention, exhibit remarkably decreased productivity, tensile strength and tensile elongation, and greatly increased sheet thickness variation.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polycarbonate resin composition for carrier tapes comprising:
about 0.5 to about 5 parts by weight of (C) carbon nanotubes, based on about 100 parts by weight of a base resin comprising about 50 to about 97% by weight of (A) a polycarbonate resin and about 3 to about 50% by weight of (B) a rubber-modified aromatic vinyl resin (B1), a semi-crystalline polymer resin (B2) or a mixture thereof, wherein the polycarbonate resin composition for carrier tapes has a surface resistance of about 10⁵Ω/□ or less.

2. The polycarbonate resin composition for carrier tapes of claim 1, wherein the mixture comprises the rubber-modified aromatic vinyl resin (B1) in an amount of about 20 to about 80% by weight and the semi-crystalline polymer resin (B2) in an amount of about 20 to about 80% by weight.

3. The polycarbonate resin composition for carrier tapes of claim 1, wherein the polycarbonate resin (A) has a weight-average molecular weight of about 10,000 to about 200,000 g/mol.

4. The polycarbonate resin composition for carrier tapes of claim 1, wherein the rubber-modified aromatic vinyl resin (B1) is an acrylonitrile-butadiene-styrene copolymer (ABS) resin, a styrene-ethylene-butadiene-styrene copolymer (SEBS) resin, or a combination thereof.

5. The polycarbonate resin composition for carrier tapes of claim 1, wherein the semi-crystalline polymer resin (B2) is polyalkylene terephthalate, ethylene vinyl acetate, or a combination thereof.

6. The polycarbonate resin composition for carrier tapes of claim 5, wherein the polyalkylene terephthalate is polybutylene terephthalate (PBT), polyethylene terephthalate (PET), or a combination thereof.

7. The polycarbonate resin composition for carrier tapes of claim 1, wherein the rubber-modified aromatic vinyl resin (B1) is an acrylonitrile-butadiene-styrene copolymer (ABS) resin, and the semi-crystalline polymer resin (B2) is a polybutylene terephthalate (PBT) resin.

8. The polycarbonate resin composition for carrier tapes of claim 1, wherein the rubber-modified aromatic vinyl resin (B1) is a styrene-ethylene-butadiene-styrene copolymer (SEBS) resin, and the semi-crystalline polymer resin (B2) is an ethylene vinyl acetate resin.

9. The polycarbonate resin composition for carrier tapes of claim 1, wherein the carbon nanotubes (C) have an average diameter of about 0.5 to about 100 nm and an average length of about 0.005 to about 100 μm.

10. The polycarbonate resin composition for carrier tapes of claim 1, wherein the carbon nanotubes (C) have an aspect ratio of about 500 to about 5,000.

11. A molded article prepared from the polycarbonate resin composition for carrier tapes of claim 1.

12. The molded article of claim 11, wherein the molded article is an embossed carrier tape.

13. The molded article of claim 11, wherein the molded article has a surface resistance of about 10⁴ to about 10⁵Ω/□ measured in accordance with ASTM D 257.

14. The molded article of claim 11, wherein the molded article has a productivity of about 6.8 to about 8.5 m/min measured using a sheet having a size of 120 mm (width)×0.4 mm (thickness), and has a sheet thickness variation of less than about 1%.
